(19) United States
(12) Patent Application Publication
(10) Pub. No.: US 2017/0193431 A1
(43) Pub. Date: Jul. 6, 2017

(54) PPE INVENTORY ASSISTANCE TOOL FOR FIRE DEPARTMENTS

(71) Applicant: Honeywell International Inc., Morris Plains, NJ (US)

(72) Inventors: Marcus Grams, Middletown, OH (US); Jennifer Brust, Bellbrook, OH (US); Brian Marenco, Coatesville, PA (US)

(21) Appl. No.: 14/986,440

(22) Filed: Dec. 31, 2015

(51) Int. Cl. G06Q 10/08; G06F 17/30

(52) U.S. Cl. CPC G06Q 10/087; G06F 17/30528; G06F 17/30525

(57) ABSTRACT

A method (10) and system (12) are disclosed for altering in inventory (14) of different types (16) of PPE in order to provide either a desired spare coverage for a group (18) of PPE users (20), or to provide an exact size match or a closest fit size match for a specific type (16) for one or more of the users (20).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

This disclosure relates to personal protective equipment, and more specifically to inventories of personal protective equipment that are maintained and utilized by organizations having a group of personal protective equipment users.

### BACKGROUND

Not all Fire Departments (FD's) can afford two sets of Personal Protective Equipment (PPE) gear for their fire fighters (FF's) so they typically try to order a small quantity of common sizes. FD's are hesitant to make this purchase because they don't always know what the common sizes are and what quantity should be ordered. When an event occurs that results in numerous items being damaged and immediately needing replacement or a single firefighter (FF) needs a replacement garment, FD's don't have a clear picture to what sizes they have in inventory to fulfill the need quickly. FD's often don't know what their inventory gaps are. All of the above can be said for many organizations whose personnel are users of personal protective equipment that have sizes specific to each of the users.

### SUMMARY

In accordance with one feature of this disclosure, a method is provided for altering an inventory of a specific type of personal protective equipment to provide a desired spare coverage for a group of personal protective equipment users. The method includes the steps of:

(a) storing in at least one electronic memory device:
a users' database of personal protective equipment users and sizing information for each said user corresponding to a specific type of personal protective equipment;
an inventory database of a current Inventory of the specific type of personal protective equipment and the sizing information for each individual piece of personal protective equipment in the inventory database; and
a sizing tolerance database of sizing tolerances corresponding to each individual piece of personal protective equipment in the inventory database;

(b) operating an electronic processing system associated with the at least one memory device to execute logic that accesses the databases and identifies a recommended quantity to acquire of each specific size of the specific type of personal protective equipment so as to provide a desired spare coverage of the specific type of personal protective equipment for the users in the user database; and

(c) altering the current inventory by acquiring a quantity of each specific size of the specific type of personal protective equipment based upon the recommended quantities from step (b).

As one feature, the desired spare coverage is for 100% of the users in the users' database.

In one feature, the desired spare coverage is for less than 100% of the users in the user's database.

According to one feature, the desired spare coverage is limited by a predetermined total quantity of the specific type of personal protective equipment that may be acquired to provide the desired spare coverage.

As one feature, the desired spare coverage requires an exact match for the sizing information of each user in the users' database.

In one feature, the desired spare coverage allows for a closest fit to the sizing information of each user in the users' database, with the closest fit being determined based upon the sizing tolerances in the sizing tolerance database with respect to the sizing information in the users' database.

According to one feature, step (b) further comprises providing an electronic visual display showing at least one of: the quantify of each specific size in the current inventory; a distribution of said quantities of each specific size in the current inventory; the quantity of each specific size in the users' database; a distribution of the quantities of each specific size in the users' database; and a distribution of the quantities in an altered inventory if the current inventory is altered by the recommended quantities from step (b).

As one feature, the current inventory in the inventory database is subdivided into an active inventory of each of the specific type of personal protective equipment that is assigned to each user in the users' database and an on-the-shelf inventory of each of the specific type of personal protective equipment that is unassigned but available in the current inventory.

In one feature, a method is provided for altering an inventory of several specific types of personal protective equipment to provide a desired spare coverage for a group of personal protective equipment user. The method comprising the steps of:

(a) storing in at least one electronic memory device:
a users' database of personal protective equipment users and sizing information for each said user corresponding to each of the several specific types of personal protective equipment;
an inventory database of a current inventory of each of the several specific types of personal protective equipment and the sizing information for each individual piece of personal protective equipment in the inventory database; and
a sizing tolerance database of sizing tolerances corresponding to each individual piece of personal protective equipment in the inventory database;

(b) operating an electronic processing system associated with the at least one memory device to execute logic that accesses the databases and identifies a recommended quantity to acquire of each specific size of at least one of the several specific types of personal protective equipment so as to provide a desired spare coverage of the at least one of the several specific types of personal protective equipment for the users in the user database; and

(c) altering the current Inventory by acquiring a quantity of each specific size of the at least one of the several specific types of personal protective equipment based upon the recommended quantities from step (b).

According to one feature, the desired spare coverage is for 100% of the users in the users' database.

As one feature, the desired spare coverage is for less than 100% of the users in the user's database.

According to one feature, the desired spare coverage is limited by a predetermined total quantity of the specific type of personal protective equipment that may be acquired to provide the desired spare coverage.

As one feature, the desired spare coverage requires an exact match for the sizing information of each user in the users' database.

In one feature, the desired spare coverage allows for a closest fit to the sizing information of each user in the users' database, with the closest fit being determined based upon the sizing tolerances in the sizing tolerance database with respect to the sizing information in the users' database.

According to one feature, a method is provided for providing a closest fit spare from an inventory of a specific type of personal protective equipment to a user selected from a group of personal protective equipment users. The method includes the steps of:

(a) storing in at least one electronic memory device:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;

(b) operating an electronic processing system associated with the at least one memory device to execute logic that accesses the databases and identifies a closest fit spare from the inventory database for a user selected from the users' database; and

(c) pulling the closest fit spare from the current inventory and providing the closest fit spare to the selected user.

As one feature, a personal protective equipment inventory assistance computing system is provided and includes:

at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;

an electronic processor having executable logic to access the databases in the memory device and to identify at least one of:
a piece of personal protective equipment in the current inventory database that is an exact sizing match based upon the sizing information provided for a selected user from the users' database; and
a piece of the personal protective equipment in the current inventory database that has a closest fit sizing for the selected user based upon the sizing information the selected user and the sizing tolerances for each piece of personal protective equipment in the sizing tolerance database; and

a visual display operatively connected to the electronic processor for displaying to an operator of the system the information identified by the electronic processor.

In one feature, a personal protective equipment inventory assistance computing system is provided and includes:

at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
   a sizing tolerance database of sizing tolerances corresponding to each individual piece of personal protective equipment in the inventory database;

an electronic processor having executable logic to access the databases in the memory device and to identify a recommended quantity to acquire of each specific size of the specific type of personal protective equipment so as to provide a desired spare coverage of the specific type of personal protective equipment for the users in the user database; and

a visual display operatively connected to the electronic processor for displaying to an operator of the system the information identified by the electronic processor.

According to one feature, a non-transitory computer readable medium storing logic is provided which when executed by a processor includes a personal protective equipment inventory assistance computing tool. The personal protective equipment inventory assistance computing tool includes logic for;

accessing at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;

identifying at least one of:
a piece of personal protective equipment in the current inventory database that is an exact sizing match based upon the sizing information provided for a selected user from the users' database; and
a piece of the personal protective equipment in the current inventory database that has a closest fit sizing for the selected user based upon the sizing information the selected user and the sizing tolerances for each piece of personal protective equipment in the sizing tolerance database; and

generating a visual display of the information identified by the electronic processor.

In one feature, a non-transitory computer readable medium storing logic is provided which when executed by a processor includes a personal protective equipment inventory assistance computing tool. The personal protective equipment inventory assistance computing tool includes logic for;

accessing at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;

identifying a recommended quantity to acquire of each specific size of the specific type of personal protective equipment so as to provide a desired spare coverage of the specific type of personal protective equipment for the users in the user database; and

generating a visual display of the information identified by the electronic processor.

Other features and advantages will become apparent from a review of the entire specification, including the appended claims and drawings.

### BRIEF DESCRIPTION OF THE DRAWINGS

FIG. 1 is a diagrammatic representation of a method according to this disclosure;

FIG. 2 is a diagrammatic representation of a system according to this disclosure;

FIG. 3 is a representation of a visual display showing the distribution of each specific size of a particular type of personal protective equipment in an inventory;

FIG. 4 is a representation of a visual display showing a distribution and quantity of sizing information for a group of firefighters of a specific fire department associated with the inventory of FIG. 3;

FIG. 5 is a visual display showing the quantities to acquire for each specific size of a particular type of personal protective equipment in order to achieve a desired spare coverage in a future state inventory;

FIG. 6 is a visual display showing the details of each specific piece of each specific type of personal protective equipment assigned to a selected firefighter, with one of the specific pieces being selected in order to find a spare in the current inventory of a fire department; and

FIG. 7 is a visual display of the “closest fit” matches determined by the method and system according to this disclosure for the selected firefighter and the selected piece of personal protective equipment of FIG. 6.

### DETAILED DESCRIPTION

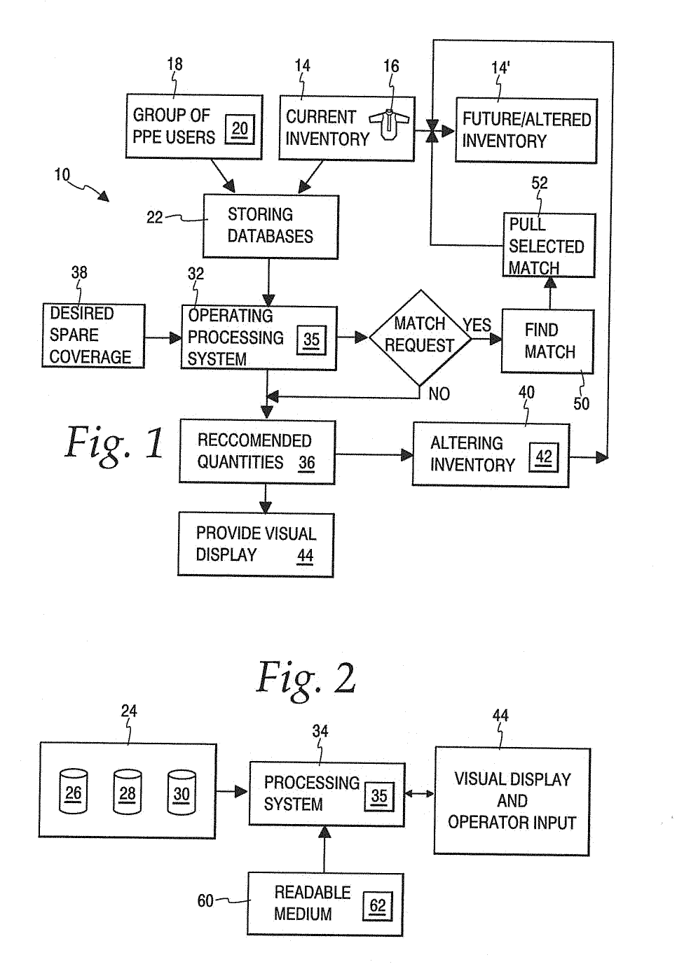

With reference to FIGS. 1 and 2, a personal protective equipment (PPE) inventory assistance method 10 and system 12 are shown. The method 10 is provided for altering an inventory 14 of a specific type 16 of PPE, such as, for example, a firefighter's coat 16, to provide a desired spare coverage of the coat 16 for a group 18 of PPE users 20, such as, for example, a FD 18 of FF's 20. The system 12 provides the capability to determine either an exact size match or a closest fit size match for the specific type 16 of PPE for one or more of the users 20, and/or to determine a quantity of each size of the specific type 16 of PPE to add to the current inventory 14 to meet a desired % spare coverage in a future/altered state 14′ of the current inventory 14.

The method 10 includes the step 22 of storing in at least one electronic memory device 24:
a users database 26 of the PPE users 20 and sizing information for each of the users 20 corresponding to the specific type 16 of PPE;
an inventory database 28 of the current inventory 14 of the specific type 16 of PPE and the sizing information for each individual piece of the personal protective in the inventory database 28; and
a size intolerance database 30 of sizing tolerances corresponding to each individual piece of PPE in the inventory database 28.

The method 10 further includes the step 32 of operating an electronic processing system 34 associated with the at least one memory device 24 to execute logic 35 that accesses the databases 26, 28 and 30 and identifies a recommended quantity 36 to acquire of each specific size of the specific type 16 of PPE so as to provide a desired spare coverage 38 of the specific type 16 of PPE for the users 20 in the user database 26. The method 10 further includes the step 40 of altering the current inventory 14 by acquiring a quantity 42 of each specific size of the specific type 16 of PPE based upon the recommended quantities 36 from the step 32 and by adding those quantities 42 to the current inventory 14 to create a future state/altered inventory 14′.

The method 10 can determine the recommended quantities 36 based upon either a desired spare coverage 38 for 100% of the users 20 in the user's database 18, or for a desired spare coverage 38 that is for less than 100% of the users 20 in the user's database 18. It should be understood that as used herein the “desired spare coverage” is intended to mean providing a spare piece of the specific type 16 of PPE for a specified percentage of the users 20, and that the term “percent coverage” is intended to mean the “specified percentage of the users 20”.

The method 10 can also determine the recommended quantities 36 when the desired spare coverage 38 is limited by a predetermined total quantity of the specific type 16 of PPE that may be acquired to provide the desired spare coverage 38. For example, a particular FD 18 may only have enough funds to purchase 100 additional coats 16, so the total quantity would be limited to 100 and the recommended quantities 36 would be based upon this limitation.

Furthermore, the method 10 can determine the recommended quantities 36 based either on a requirement for an exact match for the sizing information of each user 20 in the users database 26, or based upon a “closest fit” to the sizing information of each user 20 in the users database 26, with the closest fit being determined based upon the sizing tolerances in the sizing tolerance database 30 with respect to the sizing information in the users database 26. In this regard, the sizing tolerances in the sizing tolerance database 30 may be based upon proprietary data obtained from the manufacturer of the specific type 16 of PPE and the closest fit will be based upon an algorithm that determines the closest fit based upon the tolerances and the sizing information in the users database 26.

Typically, the current inventory 14 in the inventory database 28 is subdivided into an active inventory of each of the specific type 16 of PPE that is assigned to each user 20 in the user's database 26, and an on-the-shelf inventory of each of the specific type 16 of PPE that is unassigned but available in the current inventory. The current inventory 14 in the inventory database 28 may also be further into a “loaner” inventory which is the inventory of each specific type 16 of PPE that is intended only to be temporarily loaned to a user 20, rather than permanently assigned to a user 20. Typically, the “loaner” inventory is made up of pieces of PPE that have been slightly damaged or that have a significant amount of prior usage.

Advantageously, the method 10 further provides an electronic visual display 44 that, in the illustrated embodiment, shows any of:

the quantity of each specific size in the current inventory;

a distribution of the quantities of each specific size in the current inventory;

the quantity of each specific size in the users data base 26;

a distribution of the quantities of each specific size in the users data base; and

a distribution of the quantities in an altered inventory 14′ if the current inventory 14 is altered by the recommended quantities from step 32.

The visual display 44 can also show each of the above in terms of the active inventory of each specific type 16 of PPE, an on-the-shelf inventory of each specific type 16 a PPE, and/or the loaner inventory of each of the specific type 16 of PPE.

Advantageously, the method 10 can be applied to an inventory 14 containing a single specific type of PPE, or to inventory 14 containing several different specific types 16 of PPE, with the user database 26 containing the sizing information for each of the users 20 corresponding to each of the different specific types 16 of PPE, and the sizing tolerance database 30 including sizing tolerances corresponding to each individual piece of each of these several different types 16 of PPE in the inventory 14, with the method 10 and system 12 being capable of providing a recommended quantity 36 to acquire of each specific size of each of the different types 16 of PPE based on a desired spare coverage for each of the different types 16 of PPE in the inventory 14.

As one feature, the method 10 can include the step 50 of operating the electronic processing system 34 to execute logic that accesses the databases 26,28,30 and identifies either an exact size match from the inventory database 28 for a user 20 selected from the user database 26, or, if an exact size match is not available in the inventory 14, a closest fit size match in the inventory 14 for the user 20 selected from the users database 26. Furthermore, the method 10 can provide a range of “closest fit” sizes of the specific type 16 of PPE from the inventory 14 so as to allow an operator of the system 12 to select which of the “closest fit” sizes to select for the particular user 20. For example, if the sizing information for a particular user 20 is a size 40 chest and a size 36 sleeve, the algorithm may indicate that a size 38 chest and a size 36 sleeve coat 16 in the current inventory 14 is the closest fit based upon a size tolerance of +1 inch and −½ Inch for a size 38 chest coat 16, or the algorithm may provide a selection of a size 38 chest/36 sleeve coat and a size 38 chest/34 sleeve coat based upon the same tolerance for the size 38 chest and a tolerance of +/−½ inch for both the size 36 and size 34 sleeve, and the operator may select between the two sizes based upon whether or the particular user 20 prefers a longer or shorter sleeve. The method 10 then further includes the step 52 of pulling the selected replacement piece of PPE that is an exact size match, or the selected replacement piece of PPE that is the closest fit, from the current inventory 14 and providing the replacement piece to the selected user 20.

As one feature, a non-transitory computer readable medium 60 can be provided storing the logic that when executed by the processor 34 includes a PPE inventory assistance computing tool 62 that performs step 32.

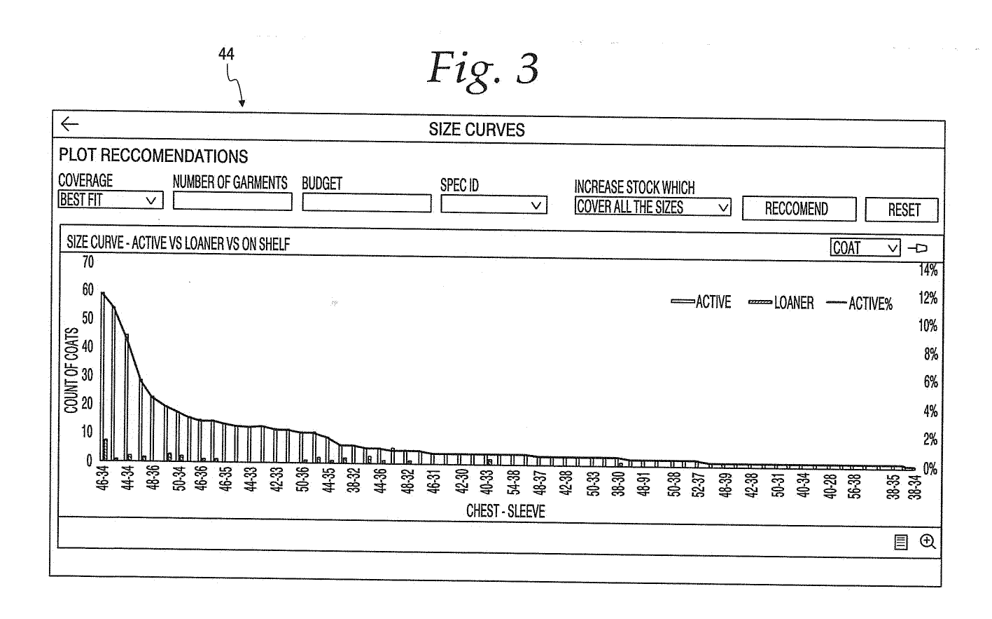

As seen in FIG. 3, the method 10 and system 12 can operate the visual display 44 to provide a screen showing the distribution of each specific size of a particular type of PPE in the inventory 14. In the illustrated embodiment, each specific chest/sleeve size of a firefighter coat 16 is shown on the horizontal axis of the graph, the count of coats is shown on the left hand vertical axis, and the percent of active inventory is shown on the right-hand vertical axis, with each specific chest/sleeve size having bars that show the active inventory and the loaner inventory. Additionally, the percent of active inventory is shown in a box associated with each specific chest/sleeve size. It should be understood that the method 10 and system 12 of this disclosure are capable of providing similar displays for each particular type of PPE in the inventory 14, and for each particular type of inventory (active, loner, on-the-shelf) is shown.

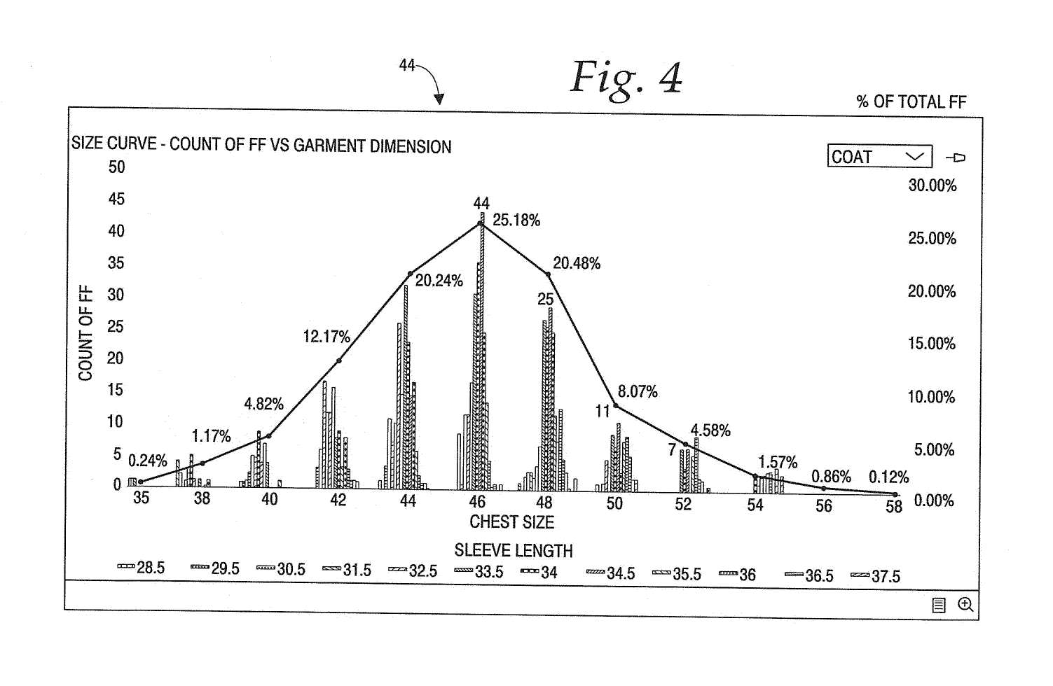

As seen in FIG. 4, the method 10 and system 12 according to this disclosure are capable of operating the visual display 44 to show a graph of the distribution of the quantities of sizing information for the group 18 of users 20 for a specific organization, such as a FD. In the Illustrated embodiment, each chest size for the users 20 is on the horizontal axis of the graph, with the count of users 20 shown on the left-hand vertical axis, and the percentage of users shown on the right-hand vertical axis, with individual bars at each chest size representing the sleeve length of each of the users 20 for that specific chest size. It should be understood that the method 10 and system 12 of this disclosure are capable of providing similar displays for each particular type of PPE in the inventory 14, and can alter the particular size measurement that is shown on the horizontal axis and the particular size measurement that is shown by individual bars.

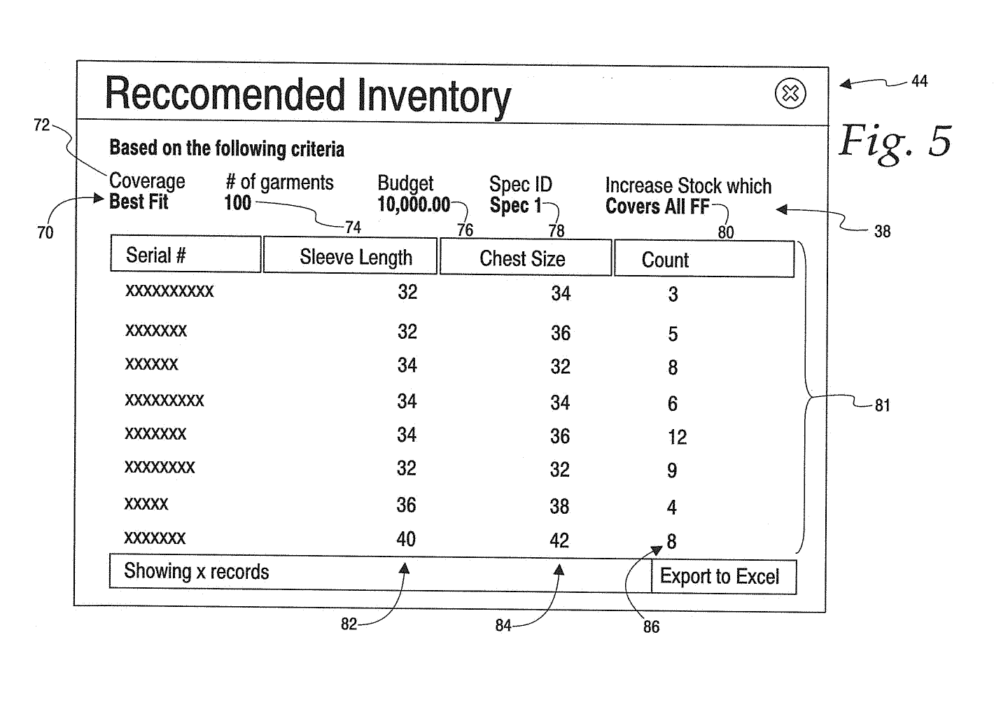

As shown in FIG. 5, the method 10 and system 12 of this disclosure are capable of operating the visual display 44 to provide a screen showing the quantities to acquire for each specific size of a particular type of PPE in order to achieve a desired spare coverage in a future/altered state inventory 14′. As shown at 70, the desired spare coverage 38 includes a request 72 for “best fit” (closest fit), a limitation 74 for the number of garments that can be acquired, a dollar budget limit 76 for the maximum dollars that can be spent in acquiring the recommended quantities, the particular specification 78 that must be met by the PPE to be acquired, and the percent coverage for the request (“Covers All FF equals 100% coverage). As shown at 80, the recommended quantities to acquire are provided, with the size specifications shown at 82 and 84 and the quantity of each size shown at 86.

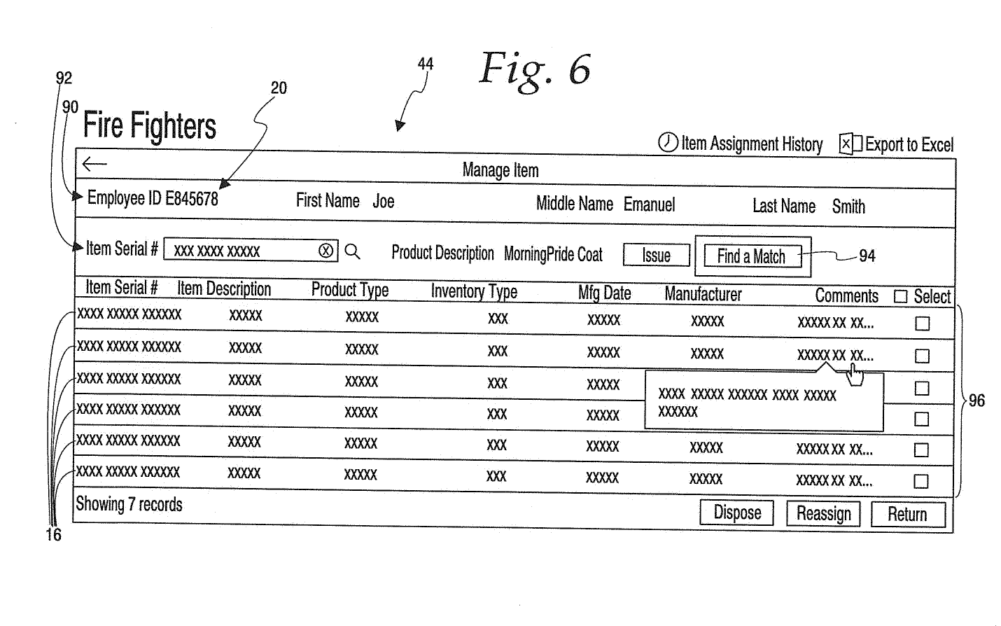

As shown in FIG. 6, the method 10 and system 12 according to this disclosure are capable of operating the visual display 44 to show the details of each specific piece of each specific type 16 of PPE assigned to a selected user 20, with one of the specific pieces being selected in order to find a replacement/spare in the current inventory 14 of a FD or other organization. In this regard, the information for the selected user 20 is shown by the fields at 90, the specific piece selected is shown by the field at 92, with a selectable icon 94 to initiate operation of the system 12 to find a match/spare/replacement, and the details for each specific piece of each specific type 16 of PPE shown in the fields at 96.

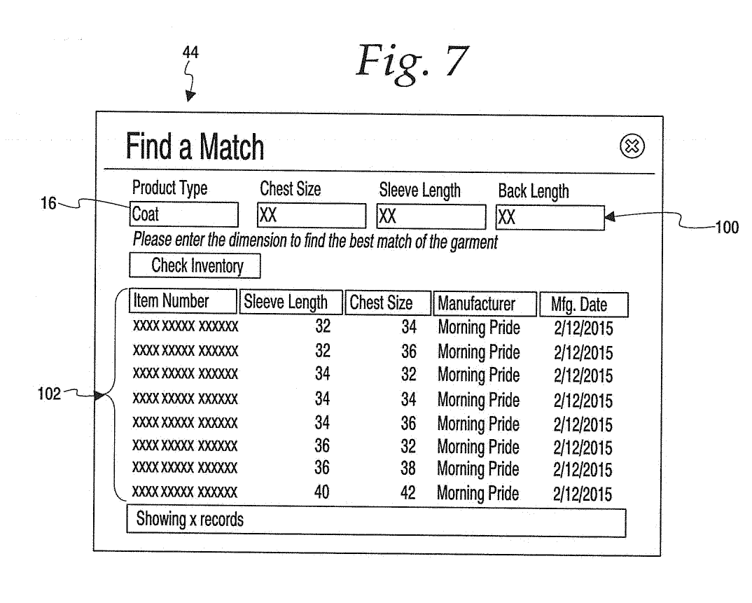

As shown by FIG. 7, the method 10 and system 12 according to this disclosure are capable of operating the visual display 44 to show the “closest fit” determined by the method 10 and system 12 for a selected user 20. In this regard, the type 16 of PPE and the corresponding sizing information for the selected user 20 is shown in the fields at 100, and the specific information for each of the “closest fit” pieces from the inventory 14 are shown in the fields at 102.

It should be appreciated that the method 10 and system 12 of this disclosure provide a visually display of the size distribution of an active inventory of PPE and/or a curve of sizes for active inventory vs. other inventory pools, with the default always current state. An operator can then choose to manipulate their % spare coverage with resulting output displaying what size inventory would need to be increased to attain that level or spare coverage. It should further be appreciated that the method 10 and system 12 of this disclosure perform analysis that can then suggest what sizes could be purchased to give a FD or other organization their desired % spare coverage. It should also be appreciated that the method 10 and system 12 of this disclosure provide for the visual display of future state inventory size distribution that can be manipulated based on desired % spare coverage. It should additionally be appreciated that the method 10 and system 12 of this disclosure perform analysis to identify exact size match in an inventory 14 with actively assigned items 16 and delivers a list of results to an operator of the method 10 and system 12, and that if no exact matches are found the method 10 and system 12 deliver a list of items 16 considered next best alternatives or “close matches” based on tolerance parameters from the manufacturer. It should further be appreciated that the method 10 and system 12 of this disclosure provide visually display comparisons of active inventory vs. on shelf inventory and other inventory pools to aid user in purchase decisions.

1. A method of altering an inventory of a specific type of personal protective equipment to provide a desired spare coverage for a group of personal protective equipment users, the method comprising the steps of:
(a) storing in at least one electronic memory device:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;
(b) operating an electronic processing system associated with the at least one memory device to execute logic that accesses the databases and identifies a recommended quantity to acquire of each specific size of the specific type of personal protective equipment so as to provide a desired spare coverage of the specific type of personal protective equipment for the users in the user database; and
(c) altering the current inventory by acquiring a quantity of each specific size of the specific type of personal protective equipment based upon the recommended quantities from step (b).

2. The method of claim 1 wherein the desired spare coverage is for 100% of the users in the users' database.

3. The method of claim 1 wherein the desired spare coverage is for less than 100% of the users in the user's database.

4. The method of claim 1 wherein the desired spare coverage is limited by a predetermined total quantity of the specific type of personal protective equipment that may be acquired to provide the desired spare coverage.

5. The method of claim 1 wherein the desired spare coverage requires an exact match for the sizing information of each user in the users' database.

6. The method of claim 1 wherein the desired spare coverage allows for a closest fit to the sizing information of each user in the users' database, with the closest fit being determined based upon the sizing tolerances in the sizing tolerance database with respect to the sizing information in the users' database.

7. The method of claim 1 wherein step (b) further comprises providing an electronic visual display showing at least one of the quantify of each specific size in the current inventory, a distribution of said quantities of each specific size in the current inventory, the quantity of each specific size in the users' database, a distribution of the quantities of each specific size in the users' database, and a distribution of the quantities in an altered inventory if the current inventory is altered by the recommended quantities from step (b).

8. The method of claim 1 wherein the current inventory in the inventory database is subdivided into an active inventory of each of the specific type of personal protective equipment that is assigned to each user in the users' database and an on-the-shelf inventory of the specific type of each of the specific type of personal protective equipment that is unassigned but available in the current inventory.

9. A method of altering an inventory of several specific types of personal protective equipment to provide a desired spare coverage for a group of personal protective equipment users; the method comprising the steps of:
(a) storing in at least one electronic memory device:
a users' database of personal protective equipment users and sizing information for each said user corresponding to each of the several specific types of personal protective equipment;
an inventory database of a current inventory of each of the several specific types of personal protective equipment and the sizing information for each individual piece of personal protective equipment in the inventory database; and
a sizing tolerance database of sizing tolerances corresponding to each individual piece of personal protective equipment in the inventory database;
(b) operating an electronic processing system associated with the at least one memory device to execute logic that accesses the databases and identifies a recommended quantity to acquire of each specific size of at least one of the several specific types of personal protective equipment so as to provide a desired spare coverage of the at least one of the several specific types of personal protective equipment for the users in the user database; and
(c) altering the current inventory by acquiring a quantity of each specific size of the at least one of the several specific types of personal protective equipment based upon the recommended quantities from step (b).

10. The method of claim 9 wherein the desired spare coverage is for 100% of the users in the users' database.

11. The method of claim 9 wherein the desired spare coverage is for less than 100% of the users in the user's database.

12. The method of claim 9 wherein the desired spare coverage is limited by a predetermined total quantity of the specific type of personal protective equipment that may be acquired to provide the desired spare coverage.

13. The method of claim 9 wherein the desired spare coverage requires an exact match for the sizing information of each user in the users' database.

14. The method of claim 9 wherein the desired spare coverage allows for a closest fit to the sizing information of each user in the users' database, with the closest fit being determined based upon the sizing tolerances in the sizing tolerance database with respect to the sizing information in the users' database.

15. A method of providing a closest fit spare from an inventory of a specific type of personal protective equipment to a user selected from a group of personal protective equipment users; the method comprising the steps of:
(a) storing in at least one electronic memory device:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;
(b) operating an electronic processing system associated with the at least one memory device to execute logic that accesses the databases and identifies a closest fit spare from the inventory database for a user selected from the users' database; and
(c) pulling the closest fit spare from the current inventory and providing the closest fit spare to the selected user.

16. A personal protective equipment inventory assistance computing system comprising:
at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;
an electronic processor having executable logic to access the databases in the memory device and to identify at least one of:
a piece of personal protective equipment in the current inventory database that is an exact sizing match based upon the sizing information provided for a selected user from the users' database; and
a piece of the personal protective equipment in the current inventory database that has a closest fit sizing for the selected user based upon the sizing information for the selected user and the sizing tolerances for each piece of personal protective equipment in the sizing tolerance database; and
a visual display operatively connected to the electronic processor for displaying to an operator of the system the information identified by the electronic processor.

17. A personal protective equipment inventory assistance computing system comprising:
at least one memory device storing:
a users' database of personal protective equipment users and sizing information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;
an electronic processor having executable logic to access the databases in the memory device and to identify a recommended quantity to acquire of each specific size of the specific type of personal protective equipment so as to provide a desired spare coverage of the specific type of personal protective equipment for the users in the user database; and
a visual display operatively connected to the electronic processor for displaying to an operator of the system the information identified by the electronic processor.

18. A non-transitory computer readable medium storing logic which when executed by a processor comprises a personal protective equipment inventory assistance computing tool, wherein the personal protective equipment inventory assistance computing tool comprises logic for:
accessing at least one memory device storing:
a users' database of personal protective equipment users and sizing Information for each said user corresponding to a specific type of personal protective equipment;
an inventory database of a current inventory of the specific type of personal protective equipment and the sizing information for each individual piece of personal protective equipment in the inventory database; and
a sizing tolerance database of sizing tolerances corresponding to each individual piece of personal protective equipment in the inventory database;
identifying at least one of:
a piece of personal protective equipment in the current inventory database that is an exact sizing match based upon the sizing information provided for a selected user from the users' database; and
a piece of the personal protective equipment in the current inventory database that has a closest fit sizing for the selected user based upon the sizing information for the selected user and the sizing tolerances for each piece of personal protective equipment in the sizing tolerance database; and
generating a visual display of the information Identified by the electronic processor.

19. A non-transitory computer readable medium storing logic which when executed by a processor comprises a personal protective equipment inventory assistance computing tool, wherein the personal protective equipment inventory assistance computing tool comprises logic for:
accessing at least one memory device storing
a users' database of personal protective equipment users and sizing information for each said user corresponding to a specific type of personal protective equipment;
an inventory database of a current inventory of the specific type of personal protective equipment and the sizing Information for each individual piece of personal protective equipment in the inventory database; and
a sizing tolerance database of sizing tolerances corresponding to each individual piece of personal protective equipment in the inventory database;
identifying a recommended quantity to acquire of each specific size of the specific type of personal protective equipment so as to provide a desired spare coverage of the specific type of personal protective equipment for the users in the user database; and
generating a visual display of the information identified by the electronic processor.
